(19) United States
(12) Patent Application Publication
(10) Pub. No.: US 2012/0095809 A1
(43) Pub. Date: Apr. 19, 2012

(54) ENERGY-SAVING EFFECT CALCULATOR

(75) Inventors: Tetsuya Abe, Musashino-shi (JP); Yoshinori Urasawa, Musashino-shi (JP)

(73) Assignee: YOKOGAWA ELECTRIC CORPORATION, Tokyo (JP)

(21) Appl. No.: 13/276,749

(22) Filed: Oct. 19, 2011

(30) Foreign Application Priority Data
Oct. 19, 2010 (JP) 2010-234698

(51) Int. Cl. G06Q 10/06

(52) U.S. Cl. 705/7.39

(57) ABSTRACT

An energy-saving effect calculator which includes a unit for determining a standard value of each of a plurality of patterns created from a past operation mode, a past demand data, and past operation data of a boiler; and a comparing unit for creating patterns of an operation mode, demand data, and operation data at a present time, and comparing a value of the pattern with the standard value, wherein at least one of a reduction in energy cost and a reduction in CO₂ is calculated based on a comparison result of the comparing unit.

### BACKGROUND

1. Technical Field

The present disclosure relates to an energy-saving effect calculator for calculating an energy-saving effect of, for example, a boiler turbine generator (BTG) system.

2. Related Art

To calculate an energy-saving effect and/or controllability improving effect of an operation in a plant, a difference between operation data before being improved and current (i.e., improved) operation data is calculated. However, the operation data changes depending on, for example, the intention of an operator who performs the operation. It is, therefore, difficult to standardize the operation data before being improved.

In this regard, in a commercial, industrial or civilian energy plant, a calculation method using an average cost unit is conventionally used to calculate a reduction in energy cost achieved when energy-saving measures are taken in the energy plant.

The average cost unit refers to a value obtained by dividing the cost (e.g., cost of purchased electric power or fuel) of energy consumed in a predetermined period (e.g., one year) by the amount of generated energy (e.g., kWh for electric power, or Kcal for thermal energy).

FIG. 8 is a diagram showing a method of calculating, by using an average cost unit, a reduction in energy cost achieved when energy-saving measures are taken. A reduction in energy cost C is calculated according to the following equation:

C=(UA−UB)×E

where “UA” denotes an average cost unit of a period A during which the energy-saving measures are not taken, “UB” denotes an average cost unit of a period B during which the energy-saving measures are taken, and “E” denotes a total amount of energy generated during a period (A+B).

The documents that describe the related art are listed below.

### Patent Document 1: Japanese Patent Application Laid-Open No. 11-328152

### Patent Document 2: Japanese Patent Application Laid-Open No. 08-95604

### SUMMARY

An energy-saving effect calculator includes: a unit for determining a standard value of each of a plurality of patterns created from an operation mode of the past, demand data of the past, and operation data of the past of a boiler; and a comparing unit for creating patterns of an operation mode, demand data, and operation data at present, and comparing a value of the pattern with the standard value, wherein at least one of a reduction in energy cost and a reduction in CO₂ is calculated based on a comparison result of the comparing unit.

### BRIEF DESCRIPTION OF THE DRAWINGS

The advantages of the invention will become apparent in the following description taken in conjunction with the drawings, wherein:

FIG. 1 is a schematic diagram illustrating the concept of an energy-saving effect calculator according to the present disclosure;

FIG. 2 is a schematic diagram illustrating a configuration of the energy-saving effect calculator according to the present disclosure;

FIG. 3 is a configuration diagram illustrating the concept of an operation mode in a plant;

FIG. 4 is a configuration diagram illustrating the concept of another operation mode in the plant;

FIGS. 5A, 5B, and 5C are explanatory diagrams showing operation modes, demand data, and operation data in a period before improvement, and FIGS. 5D, 5E, and 5F are explanatory diagrams showing operation modes, demand data, and operation data obtained by analyzing the operation data and converting the data into demand patterns;

FIG. 6 is a table for explaining the operation data before being improved;

FIG. 7A is a table for explaining the improved operation data, and FIG. 7B is a table for explaining a difference in steam flow rate (reduction in steam flow rate) between the past and the present;

FIG. 8 is an explanatory diagram showing a method in the related art of calculating, by using an average cost unit, a reduction in energy cost achieved when energy-saving measures are taken; and

FIG. 9 is a diagram showing computational implements of an embodiment of the present application.

### DESCRIPTION OF EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As described above, in the related art, a reduction in energy cost is calculated using an average cost unit. However, the average cost unit in an energy plant largely changes depending on, for example, load of an energy generator used, a type of consumed energy (e.g., electric power, heavy oil, coal, gas, and by-product energy), and hours of energy consumption (because, for example, the rate of electric power largely changes depending on hours of use).

In addition, the average cost unit used in the calculation method in the related art is calculated based only on a specific period. An operating condition of the plant changes depending on, for example, seasons, time, the number of running machines, a unit price of energy, and efficiency. According to the calculation method in the related art, therefore, an appropriate standard value of operation data cannot be obtained.

A reliable standard value of operation data can be calculated by creating patterns of the operation data using a demand balance for each operation mode (i.e., a mode that changes depending on, for example, the number of running machines, seasons, time, a unit price of energy, and efficiency). A reduction in energy cost and/or reduction in CO₂, achieved through an energy-saving effect and/or controllability improving effect, can be made evident by a difference between the standard value thus defined and a value of current operation data.

In the present embodiment, therefore, the concept of the operation mode described above is used. That is, each operation mode is set according to time, seasons, the number of running machines, a unit price of energy, and efficiency. In addition, the demand for energy in each operation mode may be sorted into a plurality of patterns. A standard value of operation data before being improved is calculated using the above modes and patterns. A difference between the standard value and a current value is calculated based on the calculation result. In this manner, a highly accurate reduction in energy cost and/or reduction in CO₂ is calculated in real time.

A first energy-saving effect calculator according to the present embodiment includes: a unit for determining a standard value of each of a plurality of patterns created from an operation mode of the past, demand data of the past, and operation data of the past of a boiler; and a comparing unit for creating patterns of an operation mode, demand data, and operation data at present, and comparing a value of the pattern with the standard value, wherein at least one of a reduction in energy cost and a reduction in CO₂ is calculated based on a comparison result of the comparing unit.

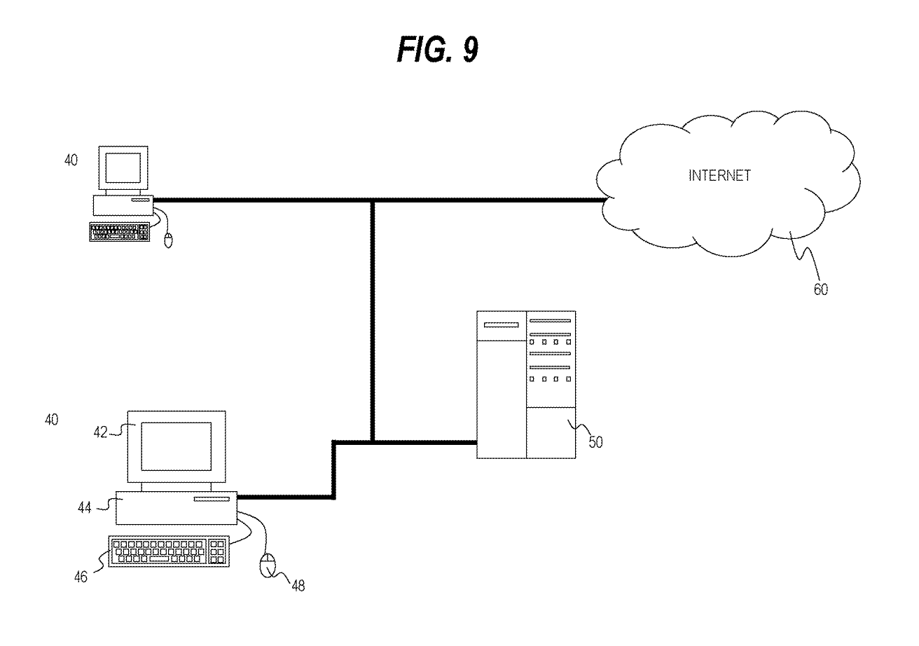

The unit for determining a standard value and can be a single computer or a plurality of computers. The comparing unit can be a single computer or a plurality of computers. Further both the unit for determining a standard value and the comparing unit can include a server. The computer or computers for the unit for determining a standard value and the comparing unit can include a monitor 42, a processing unit 44, an input unit such as a keyboard 44 and a mouse 48, as shown in FIG. 9 of the present application.

Further, computer 40 can be connected to server 50 and can also be connection to internet 60.

In a second energy-saving effect calculator according to the first energy-saving effect calculator, the operation mode is the number of running boilers, the demand data is the demand for steam and electric power, and the operation data is a main steam flow rate of the boiler.

In a third energy-saving effect calculator according to the first energy-saving effect calculator, the reduction in energy cost is a reduction in the cost of fuel consumed in all the boilers, and is calculated according to the following equation:

Reduction in the cost of fuel consumed in boilers=(reduction in steam flow rate in boiler×coefficient of converting steam in boiler into fuel×unit price of fuel).

In a fourth energy-saving effect calculator according to the first energy-saving effect calculator, the reduction in CO₂ is calculated according to the following equation:

Reduction in CO₂=(reduction in steam flow rate in boiler×coefficient of converting steam in boiler into fuel×CO₂ emission coefficient of fuel consumed in boiler).

The first to fourth energy-saving effect calculators according to the present embodiment can perform automated calculations of an energy-saving effect regardless of an operating condition. This makes it possible to reduce the number of steps compared to the related art, for calculating the effect.

The energy-saving effect calculator according to the present embodiment calculates an optimum energy-saving effect in a boiler turbine generator (BTG) system. More specifically, the energy-saving effect calculator calculates, for example, an energy-saving effect and/or controllability improving effect in a process implemented by a plurality of boilers and turbine generators for supplying steam and electric power. This makes the reduction in energy cost and/or reduction in CO₂ evident in real time.

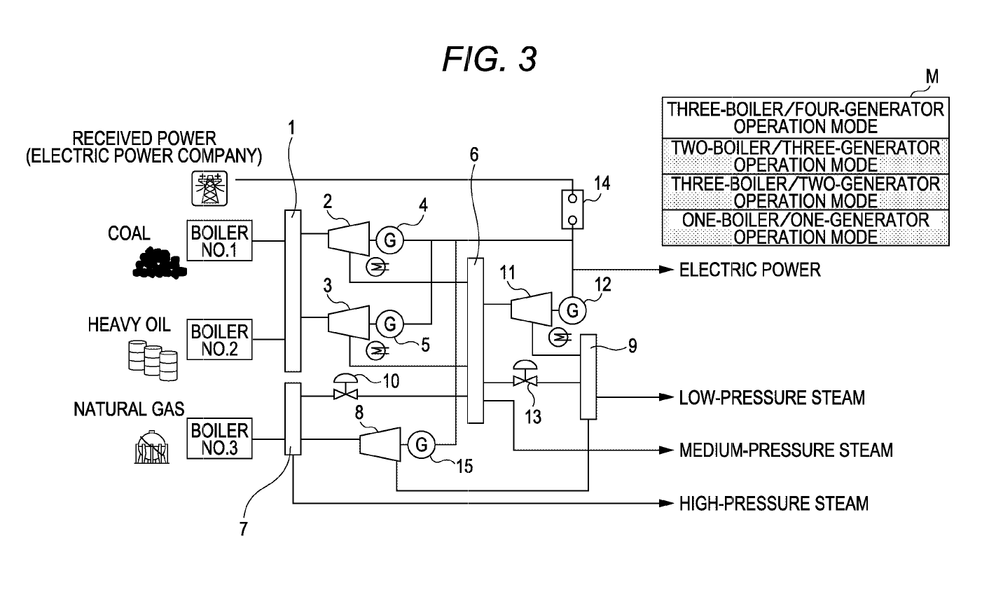

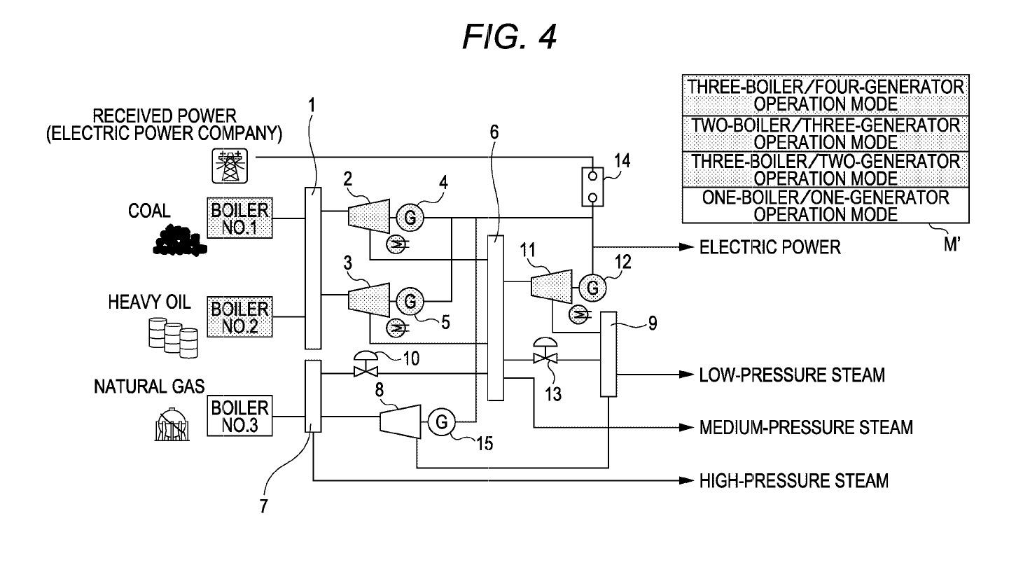

Operation modes in a plant according to the present embodiment will be described with reference to FIGS. 3 and 4. The only difference between FIGS. 3 and 4 is a display section of an operation mode denoted with M or M′. Therefore, the description of FIG. 4 will be omitted.

FIG. 3 illustrates the plant operated in a three-boiler/four-generator mode, and FIG. 4 illustrates the plant operated in a one-boiler/one-generator mode.

In this case, the three-boiler/four-generator mode refers to an operation mode in which the plant is operated with three boilers and four generators. In the three-boiler/four-generator mode, steam produced in a boiler (No. 1) through combustion of coal and steam produced in a boiler (No. 2) through combustion of heavy oil are fed to a first steam pipeline 1. The steam supplied from the first steam pipeline 1 rotates a first turbine 2 and a second turbine 3. As a result, a first generator 4 and a second generator 5 generate electric power.

After rotating the first turbine 2 and the second turbine 3, the steam is further fed to a second steam pipeline 6.

In addition, steam produced in a boiler (No. 3) through combustion of natural gas is fed to a third steam pipeline 7. The steam supplied from the third steam pipeline 7 rotates a fourth turbine 8. As a result, a fourth generator 15 generates electric power. After rotating the fourth turbine 8, the steam is fed to a fourth steam pipeline 9. The steam supplied from the third steam pipeline 7 is used in the plant as high-pressure steam and also fed to the second steam pipeline 6 through a pressure reducing valve 10.

The steam supplied from the second steam pipeline 6 rotates a third turbine 11. As a result, a third generator 12 generates electric power. After rotating the third turbine 11, the steam is fed to the fourth steam pipeline 9. The steam supplied from the second steam pipeline 6 is fed to the fourth steam pipeline 9 through a pressure reducing valve 13 and used in the plant as low-pressure steam. The steam supplied from the second steam pipeline 6 is also used in the plant as medium-pressure steam.

When a power generating capacity of the generator 4, 5, 12 or 15 is lowered, external electric power purchased from an electric power company is supplied to the plant. A switch 14 functions as an auxiliary unit for switching supply/shutoff of the external electric power (bus line).

Note that the operation modes in the plant include a two-boiler/three-generator mode, a three-boiler/two-generator mode and a one-boiler/one-generator mode in addition to the three-boiler/four-generator mode. The operation mode is determined according to an operating condition of the plant. The three-boiler/four-generator mode and the one-boiler/one-generator mode will be described in the present embodiment.

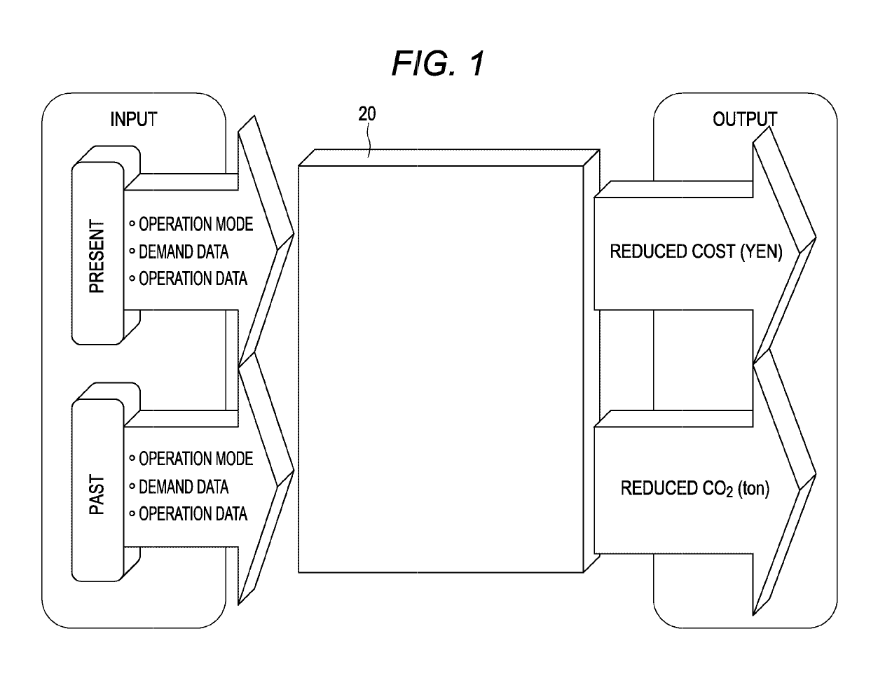

FIG. 1 is a schematic diagram illustrating the concept of an energy-saving effect calculator 20 according to the present embodiment. The calculator 20 calculates reductions in cost and CO₂. An operation mode, demand data and operation data of the past before being improved, and a current operation mode, demand data and operation data which have been improved are input to the calculator 20. Calculator 20 may be implemented on a computer 40 or server 50, for example, as shown in FIG. 9.

Based on these input data, the calculator 20 outputs the reductions in cost (currency: yen) and CO₂ (ton).

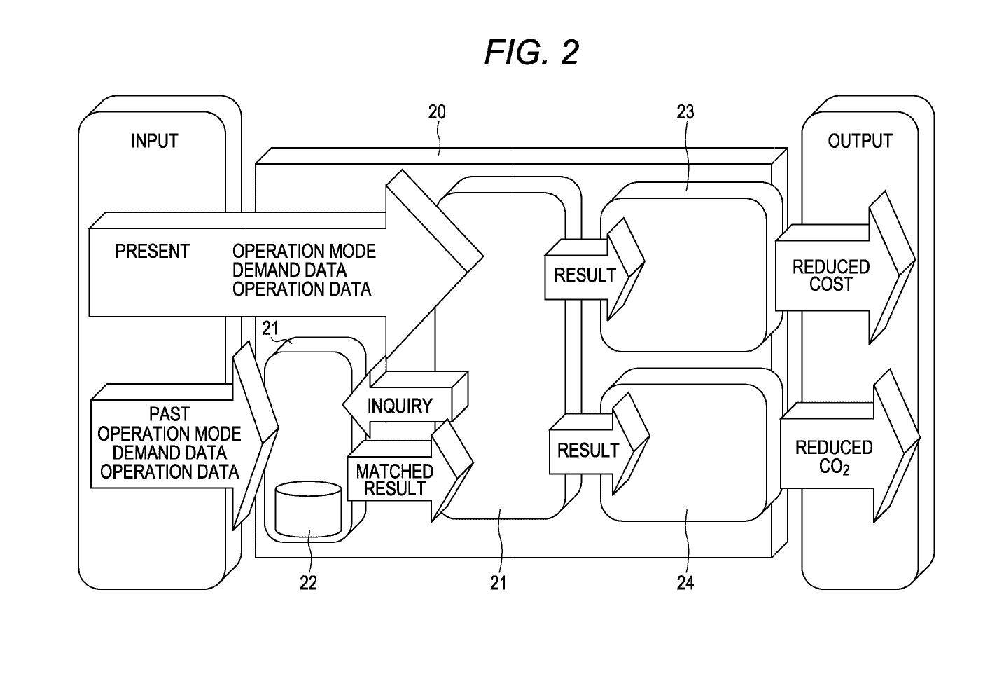

FIG. 2 illustrates a configuration of the calculator 20. The calculator 20 creates patterns of the operation mode, demand data and operation data of the past by data balance calculation. Similar patterns are put together from the plurality of created patterns and then standardized (averaged). The standardized patterns are then searched for patterns similar to those similarly created from the current operation mode, demand data and operation data. That is, it is inquired whether the patterns standardized in the past (calculation result) include patterns similar to the current data. When such patterns are found, the patterns of the past (matched result) are compared with the current patterns, a gain and an amount of CO₂ are calculated, and reductions in cost and CO₂ are output.

As illustrated in FIG. 2, the calculator 20 includes four units. More specifically, the calculator 20 includes a data balance calculating unit 21, a data comparing unit 23, a gain calculating unit 24, and a CO₂ amount calculating unit 25. The function of each unit will be described below. Both comparing unit 23 and gain calculating unit 24 can be implemented on a computer 40, or server 50, for example, as shown for example in FIG. 9.

### (1) Data Balance Calculation by the Data Balance Calculating Unit 21

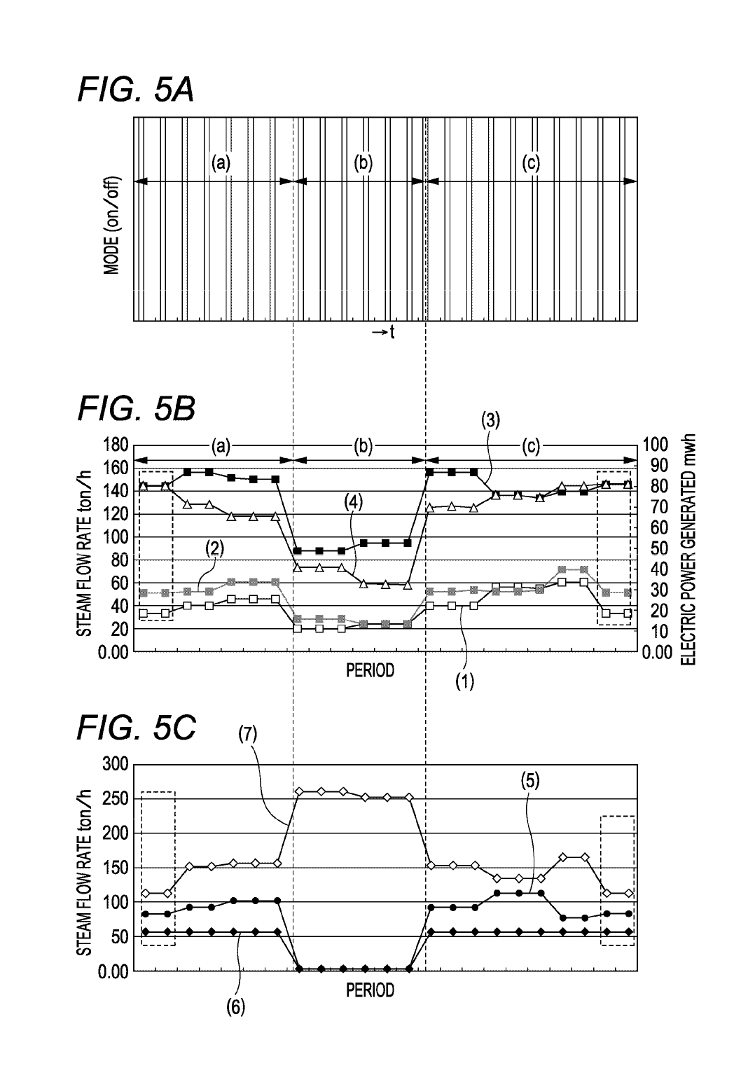

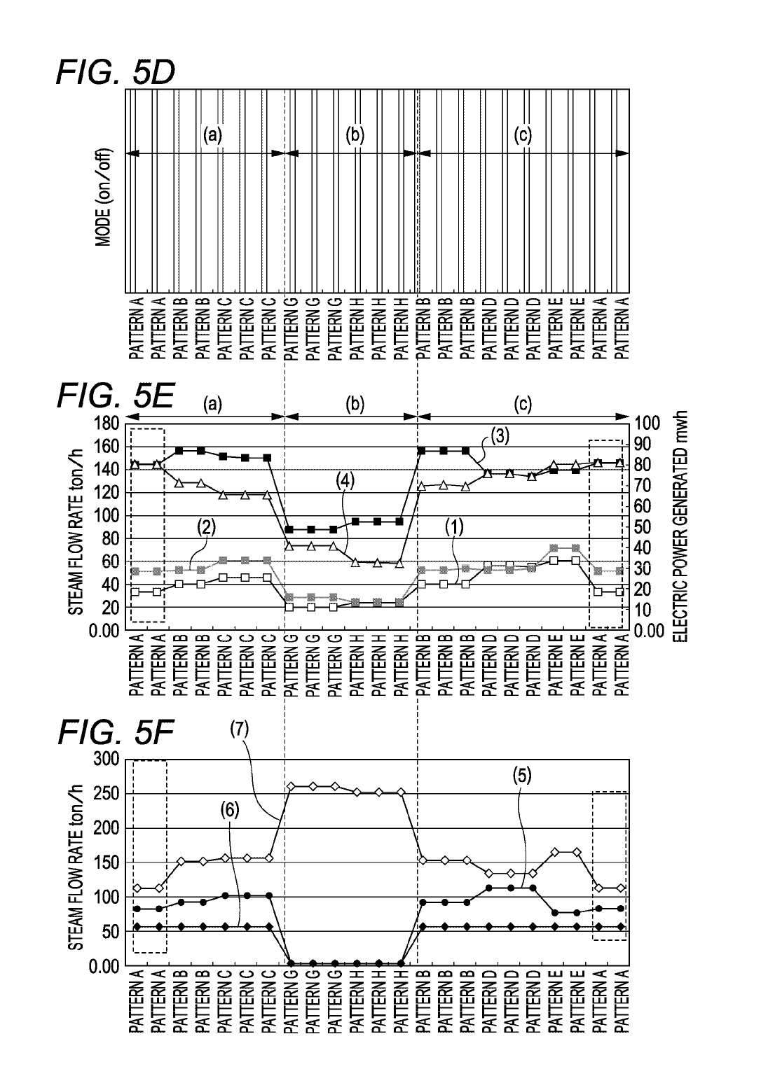

FIGS. 5A, 5B, and 5C are diagrams showing input information as work data in a period before improvement. FIGS. 5A, 5B, and 5C correspond to the operation mode, demand data, and operation data, respectively.

FIGS. 5D, 5E, and 5F are diagrams showing data analysis information obtained by analyzing the operation data and creating patterns of the demand data. FIGS. 5D, 5E, and 5F correspond to the operation mode, demand data, and operation data, respectively.

In FIGS. 5A and 5D showing the operation modes, (a) denotes a period in which the operation mode is the three-boiler/four-generator mode, (b) denotes a period in which the operation mode is the one-boiler/one-generator mode, and (c) denotes a period in which the operation mode is again the three-boiler/four-generator mode.

In FIGS. 5B and 5E showing the demand data, a vertical axis on the left shows a steam flow rate (ton/h) and a vertical axis on the right shows an amount of electric power generated (MWh). Lines (1), (2), (3), and (4) show demands for high-pressure steam, medium-pressure steam, low-pressure steam, and electric power, respectively. As is evident from these diagrams, the periods (a) and (c), in which the operation mode is the three-boiler/four-generator mode, have high demands for steam and electric power. The period (b) in which the operation mode is the one-boiler/one-generator mode, on the other hand, has low demands for steam and electric power.

FIGS. 5C and 5F corresponding to the operation data show a steam flow rate of each boiler. As is evident from these diagrams, in the periods (a) and (c) in which the operation mode is the three-boiler/four-generator mode, a main steam flow rate of the boiler (No. 1) shown by a line (5) is about 100 (ton/h), a main steam flow rate of the boiler (No. 2) shown by a line (6) is about 55 (ton/h), and a main steam flow rate of the boiler (No. 3) shown by a line (7) is about 150 (ton/h). In the period (b) in which the operation mode is the one-boiler/one-generator mode, the main steam flow rate of the boiler (No. 3) shown by the line (7) is about 250 (ton/h), and the main steam flow rate of the boiler (No. 1) shown by the line (5) and the main steam flow rate of the boiler (No. 2) shown by the line (6) are zero.

As described above, FIGS. 5D to 5F show data analysis information obtained by analyzing the operation data and creating patterns of the demand data. FIGS. 5D to 5F show created patterns A to H of the operation mode, demand data, and operation data. As shown in FIGS. 5D to SF, the periods (a) and (c) in which the operation mode is the three-boiler/four-generator mode have the pattern A, B, C, D, or E. The period (b) in which the operation mode is the one-boiler/one-generator mode has the pattern F, G, or H.

A method of creating patterns includes calculating, as the same patterns, patterns having the same balance of the demand data (in this case, four demands, i.e., demands for high-pressure steam, medium-pressure steam, low-pressure steam, and electric power). That is, the periods having the same demand pattern are regarded as those of exactly the same operation, and the operation data of these periods are made uniform (standardized).

The data balance calculating unit 21 of the calculator 20 (refer to FIG. 1) calculates data for each set of the same patterns by the data balance calculation described above. The data balance calculating unit 21 stores the calculation result in a memory 22. The data balance calculating unit can be implemented on a computer 40 or server 50, for example, as shown in FIG. 9. The data balance calculation is continuously performed during the operation in the plant. The data made into patterns are standardized per set of the same patterns and stored in the memory 22.

That is, when the work data are input to the data balance calculating unit 21 in a period before improvement corresponding to FIGS. 5A to 5C, patterns of the demand data are created for each operation mode based on a demand balance. The operation data are then grouped according to the demand pattern. As a result, a standard value of the operation data is determined for each demand pattern. The standard value is stored in the memory 22 and used as a basis for comparison with a current value.

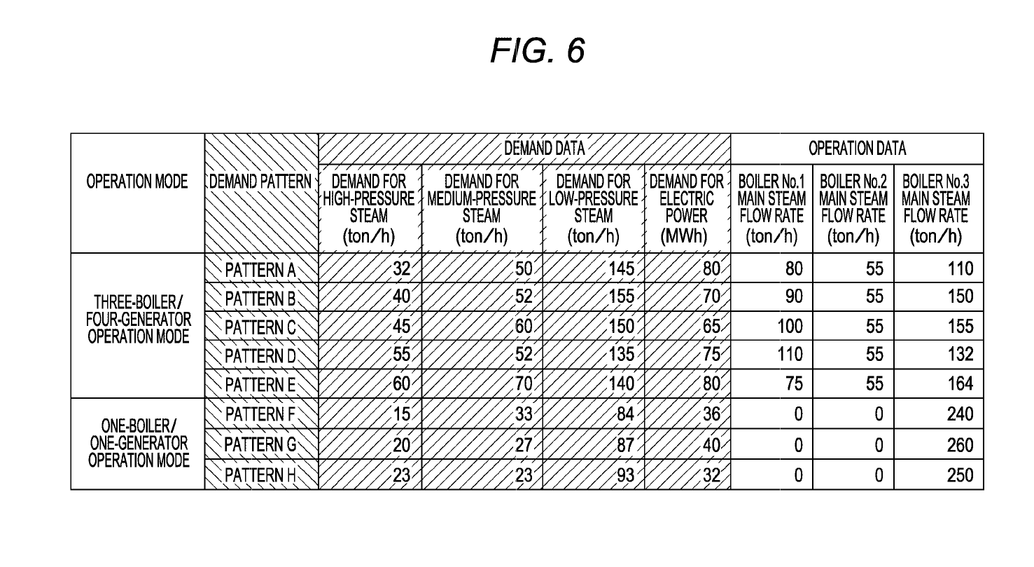

FIG. 6 shows, as standard patterns, the standard values (output results) of the operation data of each pattern. All the input data of the past are analyzed and sorted according to the operation mode and the demand pattern. Furthermore, the standard patterns are calculated. In an example shown in FIG. 6, information about eight demand patterns belonging to two operation modes is output. These pieces of information are standard data. FIG. 6 shows a relationship between the demand patterns and the demand data and operation data in each operation mode (in this case, the three-boiler/four-generator mode and the one-boiler/one-generator mode). As shown in FIG. 6, when the input work data include demand data indicating a demand for high-pressure steam as 32 (ton/h), a demand for medium-pressure steam as 50 (ton/h), a demand for low-pressure steam as 145 (ton/h), and a demand for electric power as 80 (MWh), and corresponding operation data indicating a main steam flow rate of the boiler (No. 1) as 80 (ton/h), a main steam flow rate of the boiler (No. 2) as 55 (ton/h), and a main steam flow rate of the boiler (No. 3) as 110 (ton/h), the work data are made into a demand pattern A.

In this manner, the work data are made into any of the demand patterns A to H based on the values of the demand data and the operation data included in the work data.

### (2) Data Comparison by the Data Comparing Unit 23

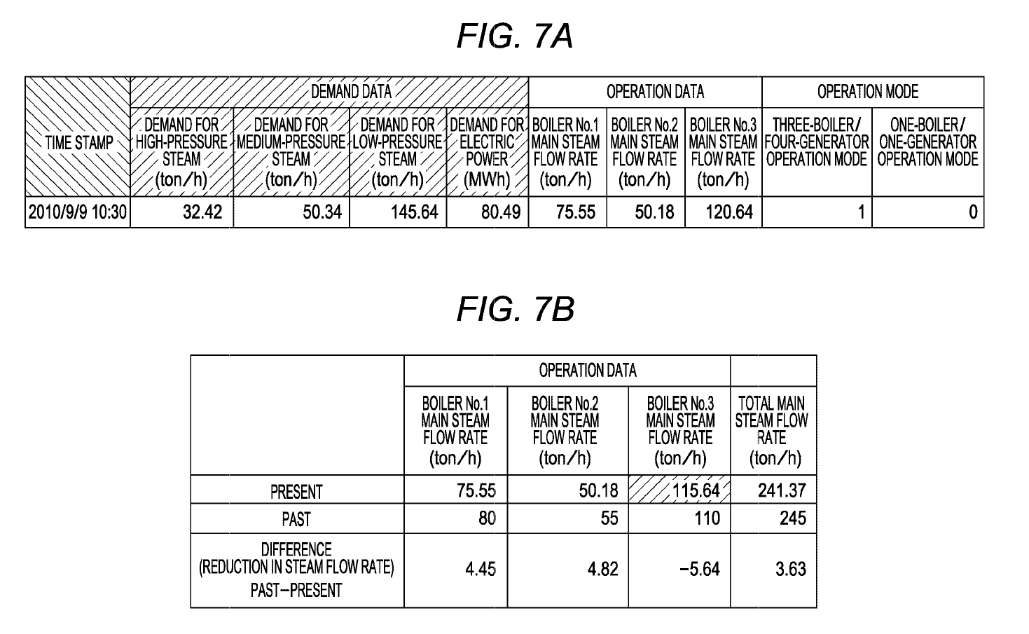

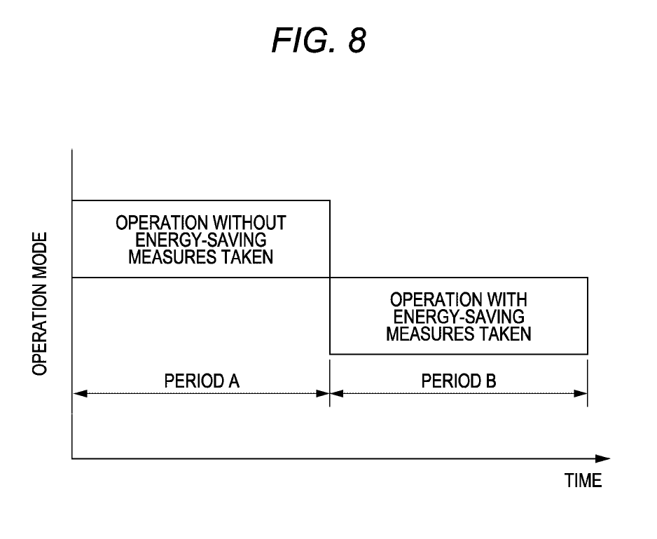

FIGS. 7A and 7B show an example of data comparison.

FIG. 7A shows improved, current operation modes, demand data and operation data. When compared with the output results of the data balance calculation of the past, these data fall into the demand pattern A shown in FIG. 6. As a result, data to be compared are specified. The calculation of a difference between the both operation data makes it possible to calculate a reduction in steam.

Referring to FIG. 7B, the operation data of the past indicates the main steam flow rate of the boiler (No. 1) as 80 (ton/h), the main steam flow rate of the boiler (No. 2) as 55 (ton/h), and the main steam flow rate of the boiler (No. 3) as 110 (ton/h). The total main steam flow rate is 245 (ton/h). Note that these values are based on the standard values of each demand pattern, which are obtained by grouping the operation data according to the demand pattern as described above and stored in the memory.

In contrast, the current operation data indicates the main steam flow rate of the boiler (No. 1) as 75.55 (ton/h), the main steam flow rate of the boiler (No. 2) as 50.18 (ton/h), and the main steam flow rate of the boiler (No. 3) as 115.64 (ton/h). The total main steam flow rate is 241.37 (ton/h).

In this example, compared with the same operation of the past (operation with substantially the same demand pattern), the main steam flow rate of the boiler (No. 3) increases by 5.64 (ton/h). On the other hand, the main steam flow rate of the boiler (No. 1) and the main steam flow rate of the boiler (No. 2) decrease by 4.45 (ton/h) and 4.82 (ton/h), respectively. Therefore, the total steam flow rate decreases by 3.63 (ton/h).

In this manner, the difference in total steam flow rate between the past and the present (reduction in total steam) is calculated as:

245−241.37=3.63 (ton/h).

### (3) Gain Calculation by the Gain Calculating Unit 24

A reduction in energy cost is calculated by associating the difference calculated in the data comparison with information on a unit price of energy (unit price of fuel) set in advance for each operation data.

That is, the reduction is calculated according to the following equation:

Reduction in cost of fuel consumed in all boilers=(reduction in steam flow rate in boiler (No. 1)×coefficient of converting steam in boiler (No. 1) into fuel×unit price of fuel consumed in boiler (No. 1))+(reduction in steam flow rate in boiler (No. 2)×coefficient of converting steam in boiler (No. 2) into fuel×unit price of fuel consumed in boiler (No. 2))+(reduction in steam flow rate in boiler (No. 3)×coefficient of converting steam in boiler (No. 3) into fuel x unit price of fuel consumed in boiler (No. 3)).

Gain calculating unit 24 can be implemented on a computer 40, or server 50, for example, as shown in FIG. 9.

### (4) Calculation of an Amount of CO₂ by the CO₂ Amount Calculating Unit 25

A reduction in CO₂ is calculated by associating the difference calculated in the data comparison with a CO₂ emission coefficient set in advance for each operation data.

That is, the reduction is calculated according to the following equation:

Total reduction in CO₂=(reduction in steam flow rate in boiler (No. 1)×coefficient of converting steam in boiler (No. 1) into fuel×CO₂ emission coefficient of fuel consumed in boiler (No. 1))+(reduction in steam flow rate in boiler (No. 2)×coefficient of converting steam in boiler (No. 2) into fuel×CO₂ emission coefficient of fuel consumed in boiler (No. 2))+(reduction in steam flow rate in boiler (No. 3)×coefficient of converting steam in boiler (No. 3) into fuel×CO₂ emission coefficient of fuel consumed in boiler (No. 3)).

Calculating unit 25 can be implemented on a computer 40, or server 50, for example, as shown in FIG. 9.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An energy-saving effect calculator comprising:
a unit for determining a standard value of each of a plurality of patterns created from a past operation mode, a past demand data, and past operation data of a boiler; and
a comparing unit for creating patterns of an operation mode, demand data, and operation data at a present time, and comparing a value of the pattern with the standard value,
wherein at least one of a reduction in energy cost and a reduction in CO₂ is calculated based on a comparison result of the comparing unit.

2. The energy-saving effect calculator according to claim 1,
wherein the operation mode is the number of running boilers, the demand data is a demand for steam and electric power, and the operation data is a main steam flow rate of the boiler.

3. The energy-saving effect calculator according to claim 1,
wherein the reduction in energy cost is a reduction in cost of fuel consumed in all the boilers, and is calculated according to the following equation:
reduction in cost of fuel consumed in boilers=(reduction in steam flow rate in boiler×coefficient of converting steam in boiler into fuel×unit price of fuel).

4. The energy-saving effect calculator according to claim 1,
wherein the reduction in CO₂ is calculated according to the following equation:
reduction in CO₂=(reduction in steam flow rate in boiler×coefficient of converting steam in boiler into fuel×CO₂ emission coefficient of fuel consumed in boiler).

5. A method of calculating an energy-saving effect comprising:
determining a standard value of each of a plurality of patterns created from a past operation mode, a past demand data, and past operation data of a boiler;
creating patterns of an operation mode, demand data, and operation data at a present time, and
comparing a value of the pattern with the standard value,
wherein at least one of a reduction in energy cost and a reduction in CO₂ is calculated based on a comparison result of the comparing unit.

6. The method of calculating an energy-saving effect according to claim 5,
wherein the operation mode is the number of running boilers, the demand data is a demand for steam and electric power, and the operation data is a main steam flow rate of the boiler.

7. The method of calculating an energy-saving effect according to claim 5,
wherein the reduction in energy cost is a reduction in cost of fuel consumed in all the boilers, and is calculated according to the following equation:
reduction in cost of fuel consumed in boilers=(reduction in steam flow rate in boiler×coefficient of converting steam in boiler into fuel×unit price of fuel).

8. The method of calculating an energy-saving effect according to claim 5,
wherein the reduction in CO₂ is calculated according to the following equation:
reduction in CO₂=(reduction in steam flow rate in boiler×coefficient of converting steam in boiler into fuel×CO₂ emission coefficient of fuel consumed in boiler).
